(19) United States
(12) Patent Application Publication
(10) Pub. No.: US 2015/0112794 A1
(43) Pub. Date: Apr. 23, 2015

(54) System And Process For Cloud Based Conversion Tracking

(71) Applicant: Melih Abdulhayoglu, Montclair, NJ (US)

(72) Inventor: Melih Abdulhayoglu, Montclair, NJ (US)

(21) Appl. No.: 14/521,393

(22) Filed: Oct. 22, 2014

Related U.S. Application Data
(60) Provisional application No. 61/894,662, filed on Oct. 23, 2013.

(51) Int. Cl. G06Q 30/02; G06F 17/30; H04L 29/08

(52) U.S. Cl. CPC G06Q 30/0246; H04L 67/02; H04L 67/10; G06F 17/30887
USPC 705/14.45

(57) ABSTRACT

A system and process are provided for a cloud based conversion tracking due to multimedia content files, including advertisements, where the multimedia content provider is not required to modify the provider's website to achieve the conversion tracking, which occurred by the user at client side clicking on a multimedia content file and causing an action considered as a conversion by the provider of the multimedia content.

### CROSS REFERENCE TO RELATED APPLICATIONS

This application claims the benefit of and priority to U.S. Provisional Application Ser. No. 61/894,662 which was filed on Oct. 23, 2013, and is incorporated by reference in its entirety herein.

### FIELD OF THE INVENTION

The present invention relates to a service where providers of multimedia content files, such as advertisers, don't have to modify their web site code to track conversions as happened due to the multimedia content being clicked on a web page and user subsequently making a purchase of product or signing up for service or causing any action, which per advertiser is classified as conversion.

### BACKGROUND

What is conversion tracking? Every multimedia content provider, such as an advertiser who submits his ads to be shown via some ad network, wants to track impact of the multimedia content or ad serving. Typically advertiser's submitted ad is shown on some publisher site via adnetwork he signed up with and in case user clicks on ad, he is taken to destination page as defined by advertiser, once user lands on destination page or on a subsequent page after browsing destination page, advertiser may want to inform adnetwork back that a certain action happened by calling ad network server provided code. This way when an advertiser logs into an ad network provided portal, he can see the data connected with clicks made by user.

Assume advertiser submitted ad is about laptop product, when user clicks on his ads and makes a purchase; advertiser may setup in adnetwork conversion value and may call back adnetwork provided code from “Thank you” page of laptop product purchase, so when advertiser logs in to adnetwork portal, he can see as which all clicks caused conversion and this way he can track conversions as which click on which ad resulted in how many conversions.

Presently, in order for advertiser to be able to achieve conversion tracking, he has to take code from adnetwork and include this code in his web page code at the place where he thinks conversion happened so that when page is browsed by user, this code calls back adnetwork to register conversion against the click, which brought user on the page.

The problem with the current approach is that the multimedia content provider, such as the advertiser, has to modify his web page code in order to achieve conversion.

### SUMMARY

The present invention overcomes the difficulty mentioned in previous section by creating a cloud based service, where the multimedia content provider is not required to modify his web site code to achieve conversion tracking.

The present invention is a system for cloud based conversion tracking of a multimedia content file(s). The system includes a computer or hand held device having a microprocessor and a memory connected to a processor bus, with the processor bus connected by circuitry to a periphery bus and a disk. The computer is operated by a user and is in communication with a web server and a database server via a web browser and at least one web site. The web browser has a browser extension. The computer is in communication with a domain name system server.

The web site receives at least one multimedia content file from a multimedia content provider and the user browsing the web at one or more one web site(s) accesses the one or more multimedia content file(s). With the present invention, the browser extension provides the multimedia content provider ability to achieve conversion tracking without modifying the web site.

The system of the present invention further includes a browser kernel which processes requests of the user and the requests are communicated to the browser extension. The browser extension analyzes the requests by a first predetermined rule to determine which of the requests need to be blocked. The browser extension analyzes by a second predetermined rule the requests which are not blocked by the first predetermined rule to determine which of the remaining requests should be communicated to the web server. The browser extension then sends to the web server the remaining user requests which are not blocked by the second predetermined rule.

The system of the present invention also includes an embodiment where a first predetermined rule includes determining if the user requests are for the at least one multimedia content file and determining if the at least one multimedia content file is unsafe or malicious, harmful to the user's device or computer. In this embodiment of the system, the unsafe or malicious or harmful multimedia content file(s) are replaced by safe multimedia content file(s).

The system of the present invention includes an embodiment where a second predetermined rule includes determining if the browser extension should communicate all URLs browsed by said user to said web server. In this embodiment of the system, the second predetermined rule further includes determining if the URLs browsed by the user match any conversion record.

The present invention includes a method of processing user browsed websites which includes operating a computer by a user and the computer is in communication with a web server and a database server via a web browser and at least one web site. The web browser has a browser extension and the computer is in communication with a domain name system server. The web site has at least one multimedia content file received from a multimedia content provider.

The method further includes browsing at least one web site and accessing at least one multimedia content file, then recording access of the one or more multimedia content file(s) by the user. The method then connects the multimedia content file(s) with a distribution campaign by a provider/publisher of the multimedia content file(s). A conversion tracking cookie of the at least one multimedia content file is placed on the computer of the user and the conversion tracking cookie is associated with the user. The method matches the browsed web site(s) with a conversion tracking rule which is associated with the distribution campaign and matches a conversion tracking rule defined for the one or more campaigns. The method registers a conversion against the at least one multimedia content file at the database server and displays the conversion against the multimedia content file for the provider/publisher of that multimedia content file to view.

In an embodiment, the method of the present invention further includes processing requests of the user with a browser kernel and the requests are communicated to the browser extension, where the browser extension analyzes the requests by a first predetermined rule to determine which of the requests need to be blocked. The browser extension analyzes, by a second predetermined rule, the requests which are not blocked by the first predetermined rule to determine which of the requests should be communicated to the web server. The browser extension then sends to the web server the requests which are not blocked by the second predetermined rule.

The method of the present invention includes an embodiment wherein the first predetermined rule includes determining if the requests are for the at least one multimedia content file and further determining if the one or more multimedia content file(s) are unsafe or malicious, or potentially harmful to the user's computer or device. The method of the present invention includes replacing the unsafe one or more multimedia content file(s) with a safe multimedia content file.

The method of the present invention includes an embodiment wherein the second predetermined rule includes determining if the browser extension should communicate all URLs browsed by the user to the web server. The method includes the second predetermined rule further includes determining if the URLs browsed by the user match any conversion record.

Advertiser simply has to indicate a given URL in system of present invention, which if visited by user after clicking on ad, to cause conversion to be recorded. As used throughout, it should be understood that the term “ad” or “advertisement” means a type of multimedia content file which may include alpha-numeric text, visual graphics, video, audio, or combinations thereof in any language or format.

### BRIEF DESCRIPTION OF THE DRAWINGS

The accompanying drawings illustrate various embodiments of the present invention and system and are part of the specification. The illustrated embodiments are merely examples of the present system and invention and do not limit the scope thereof.

FIG. 1a is a schematic illustration of the connections of a computing system.

FIG. 1b is a schematic illustration of communication process when the Internet is browsed by a user.

FIG. 1c is a schematic illustration of conversion tracking as achieved presently.

FIG. 2 is a description of the interaction between a browser and a browser extension.

FIG. 3 is an illustration of the contents of a web page.

FIG. 4 is an illustration of the contents of a web page as visible to an end user.

FIG. 5 is a diagram of the user sign up page of the present invention to enroll as an advertiser.

FIG. 6 depicts a step in the process of creating advertising campaigns in the system of the present invention.

FIG. 7 depicts the step of defining an ad group in the process for the system of the present invention.

FIG. 8 is the step of defining pricing in the system of the present invention.

FIG. 9 is the step of defining the advertisement in the system of the present invention.

FIG. 10 is the process of managing domain groups in the present invention.

FIG. 11 is the step of adding a domain group in the present invention.

FIG. 12 is a diagram of the process for editing a domain group with the present invention.

FIG. 13 is a diagram of the process of adding a domain group with the present invention.

FIG. 14 is a diagram of managing the conversion tracking in the present invention.

FIG. 15 is a diagram of creating a new conversion in the present invention.

FIG. 16 is a diagram of an advertiser defined condition of the present invention.

FIG. 17 is a diagram of an advertiser defined condition of the present invention.

FIG. 18 is a diagram of an advertiser defined condition of the present invention.

FIG. 19 is a diagram of an advertiser defined condition of the present invention.

FIG. 20 is a diagram of an advertiser defined condition of the present invention.

FIG. 21 is a flow diagram of a user browsing the web in the system of the present invention.

FIG. 22 is a flow diagram of a webserver processing user browsed URL with the present invention.

FIG. 23 is a flow diagram of the advertisement serving decisions inside an advertisement web server with the present invention.

FIG. 24 shows interface where per ad conversion can be seen by advertiser.

FIG. 25 is an illustration of computer devices.

### DETAILED DESCRIPTION

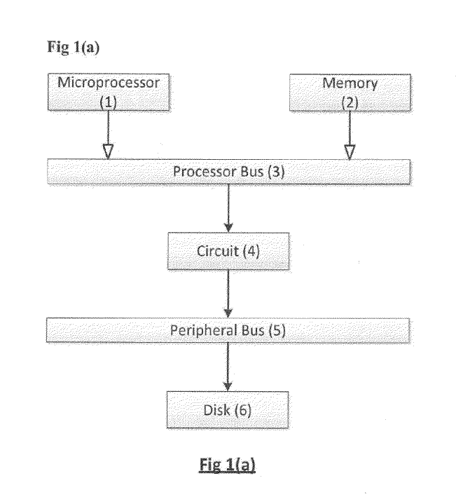

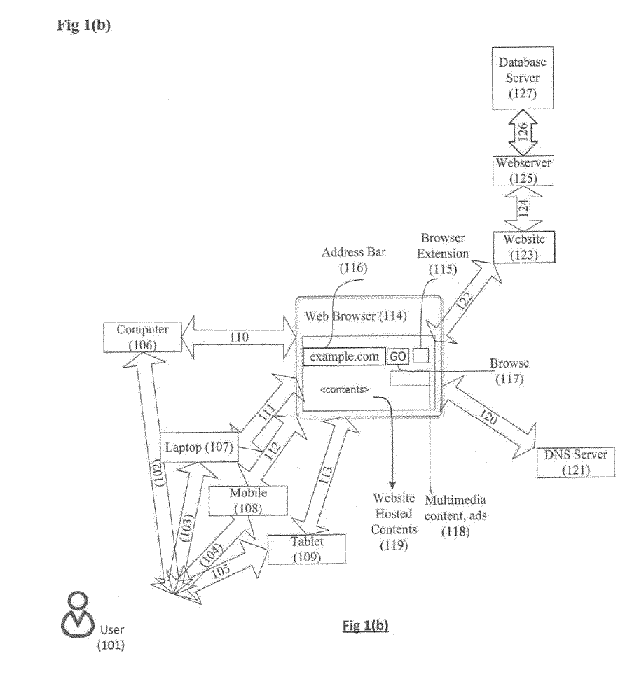

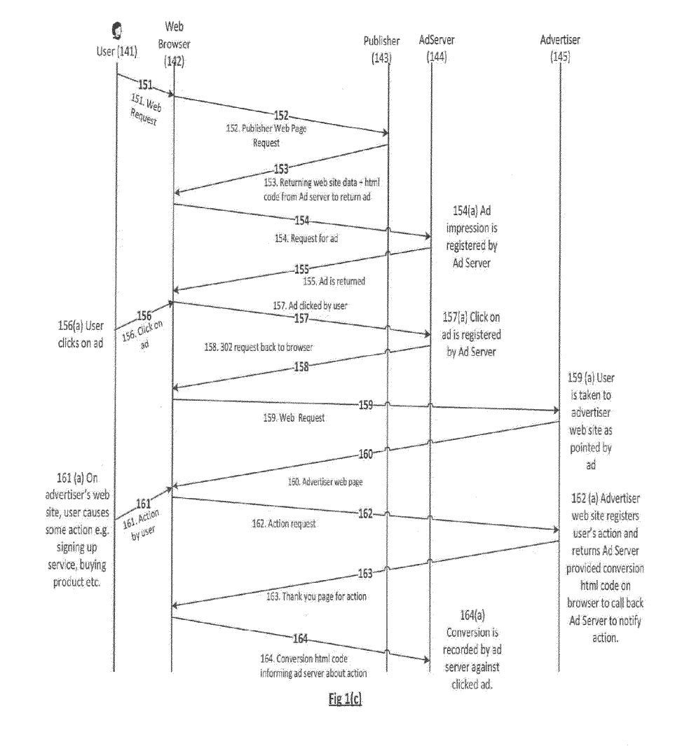

FIG. 1a illustrates a system 10 of a computer or device which includes a microprocessor 1 and a memory 2 which are coupled to a processor bus 3 which is coupled to a peripheral bus 5 by circuitry 4. The bus 5 is communicatively coupled to a disk 6. It should be understood that any number of additional peripheral devices are communicatively coupled to the peripheral bus 5 in embodiments of the invention. Further, the processor bus 3, the circuitry 4 and the peripheral bus 5 compose a bus system for computing system 10 in various embodiments of the invention. The microprocessor 1 starts disk access commands to access the disk 6. Commands are passed through the processor bus 3 via the circuitry 4 to the peripheral bus 5 which initiates the disk access commands to the disk 6. In various embodiments of the invention, the present system intercepts the disk access commands which are to be passed to the hard disk.

FIG. 1(b) is a description of how communication works when the web is browsed and shows that a user (101) can use computer (106), laptop (107), mobile (108) or a tablet (109) to launch a web browser (114) installed on that specific device to browse a specific website (123). User can enter address of some web site on Address Bar (116) and press browser specific option to indicate to browser to browse like shown in above image via button Go (117). After user presses browser specific option to navigate to a given web page as shown in above image via button Go (117), Web Browser (114) first connects to Domain Name Server (121) as configured in that device to resolve web site domain to IP address. Any user initiated request and any request made by code in browser page goes through Browser Extension (115), which can allow/re-direct or block any specific outgoing call. If call is allowed by browser extension (115), it is received by web server (125) where web site (123) is hosted. Web Server (125) in turn may connect to some Database Server (127) to return specific user requested contents back to Web Browser (114).

FIG. 1(c) shows a sequence diagram as how conversion tracking is achieved in general. A user 141 uses a web browser 142 shown via action 151, web browser in turn passes request 152 of web page to publisher 143 hosting web page, web page contents 153 are returned back to web browser 142, where while interpreting web page data, there could be HTML code in it from a given Adserver 144, this HTML code makes a request 154 for ad to AdServer 144, AdServer 144 returns ad back to web browser as shown via flow 155. Upon seeing ad on web page, user 141 may click on ad as shown via flow 156, when user clicks, web browser browses to URL defined as click URL in this case coming from AdServer 145 as shown via flow 157. AdServer 144 upon receiving click URL from user, registers in system click against ad as shown via 157(a) event and then it sends a 302 HTTP request back to web browser 142 mentioning it to browse to web page as defined by advertiser for clicked ad, this request goes to Advertiser 145 hosted contents as shown via event 159 (a) and page contents related to request are returned by advertiser hosted site as shown via flow 160. After user 141 sees web page shown resulted due to click on ad, he causes some action as shown via flow 162, this action is advertiser defined, it could be that Advertiser 145 wants user 141 to buy a product, sign up for some services or just make a specific action, which helps advertiser 145 achieve a specific business objective as he desired from ad serving; user caused actions are tracked by advertiser's site and at any point when advertiser web page thinks specific action has been caused as shown by example action of user seeing some Thank you page, advertiser page executes html code 164 as provided by AdServer to inform AdServer to record transaction against ad clicked by user.

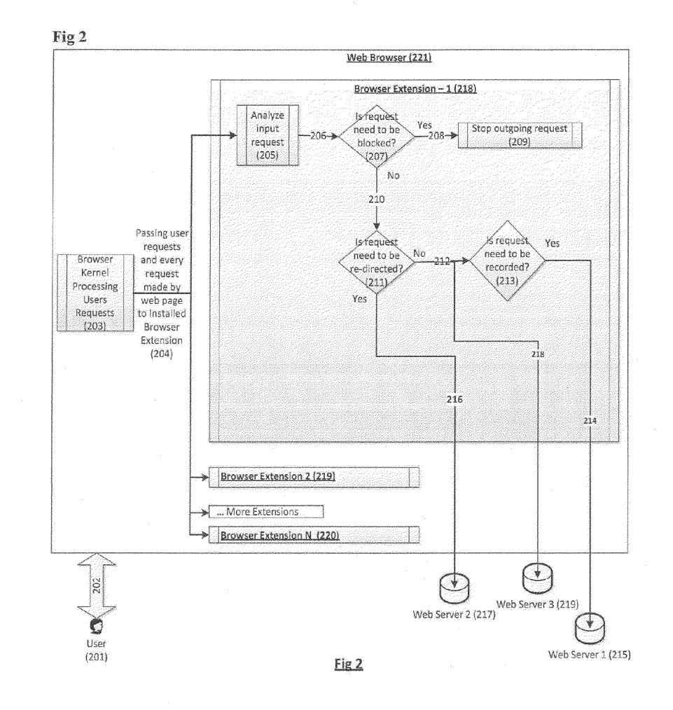

FIG. 2 is a description of the interaction between a browser and a browser extension. This defines how an extension running inside a web browser can control the outgoing requests and can also sniff all out going traffic.

FIG. 2 indicates that user (201) uses a web browser (221) to make a request for a web page, all requests from web browser (221) before being delivered to related website hosting server (215) are passed to all installed active browser extensions (218, 219, 220), when a request is passed to browser extension, it is free to just read it i.e. or said to be able to sniff it as shown in decision box 213, or can block the request as shown via flow 208 or can re-direct the request as shown via flow 216 to another web server (217), which can return contents rather original web server.

If any of the active browser extension blocks or re-directs request, it is re-directed or blocked based on which browser extension received first and decided to make a change.

The diagram indicates how the browser extension is in full control of all out going requests and can make decision as what should happen to any given request. If any of extension blocks request, request is blocked, if any of extension re-directs, it is re-directed.

Architecture as how browser passes request to browser extension is web browser technology dependent.

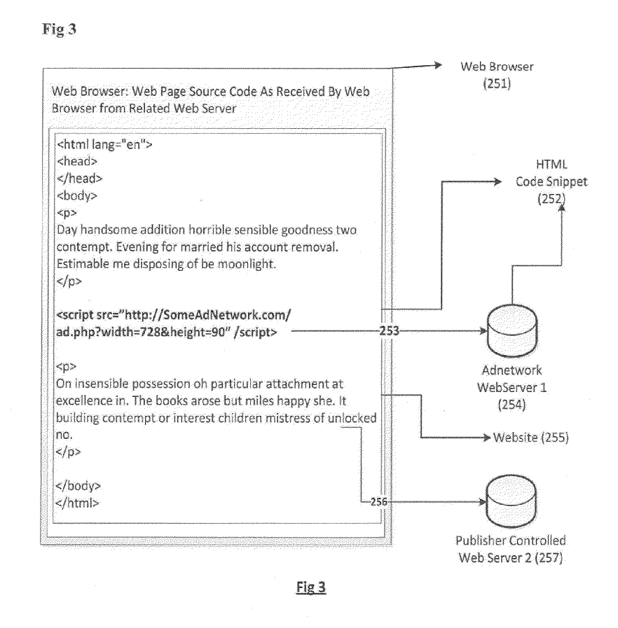

FIG. 3 is a description of a web page contents and the illustration shows a web site (607) hosted by Publisher Controlled Web Server (604) can contain HTML Code Snippet (602) from some third party Adnetwork Web Server (603) and also Website Hosted Contents (610) from its own server.

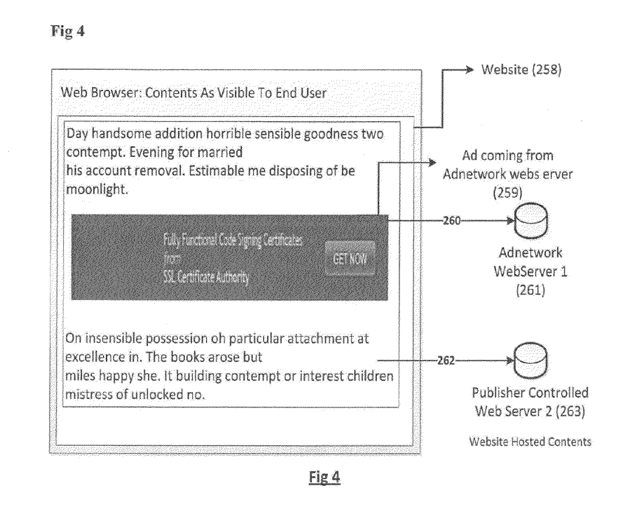

FIG. 4 is a continuation of illustration of FIG. 3 and illustrates how a website owner can take code snippet from some ad network company and embed in his web site contents, which when rendered on web page allows java script snipped to obtain data from its own web server and can show advertisement 609 based on its own logic to user. These code snippets could be also used for tracking user activity, tracking analytics about website viewers or to embed some widgets taking user to respective site. Essentially a web page can have lot of data coming from different web sources and each of web source defining what to return for a given request.

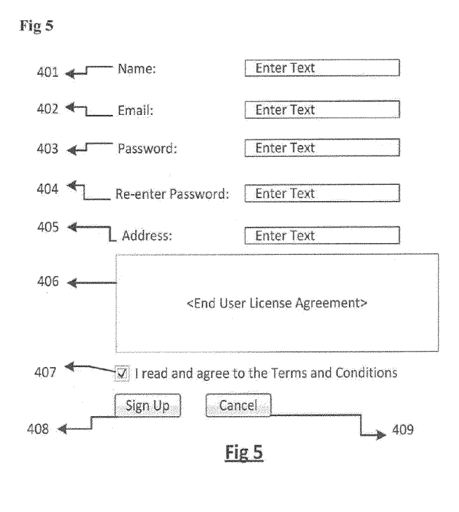

The process of creating campaigns and data creation is described in FIG. 5 through 20. FIGS. 5 to 20 describe as how after signing up advertiser can create campaigns in system of present invention and how data created by advertiser is used while making decision as which ad to show to end user when he browses Internet and also how advertiser can make use of system of present invention to achieve conversion tracking without modifying web page code.

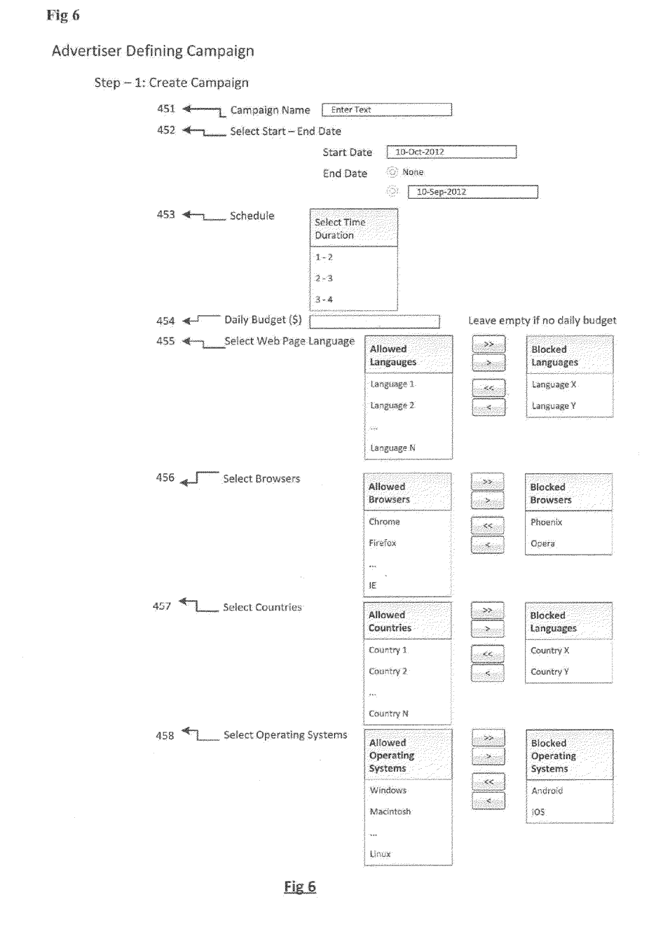

FIG. 5 is a description of the Sign Up and shows that a user can go to a web link as exposed by system of present invention to sign up as an advertiser. Here, an advertiser is required to create a login in system of present invention by providing name, email id and password. After user agrees to terms and conditions, he can press on Sign Up button to submit application to become advertiser in system. System admin evaluates advertiser sign up information and decides to approve advertiser sign up. Once advertiser is approved, he can create campaigns and data as described in FIGS. 6 through 20.

FIG. 6 is a description of the process of creating a campaign and shows that after an advertiser signs in, he will have option to create campaigns in system. In system of present invention, to be able to define an ad, you have to define a campaign and that campaign can have one or more ad groups and under a given ad group, there can be one or more ads.

A campaign is created under certain steps, defining different data items in each step:

FIG. 6 shows that to create a campaign, advertiser has to give it a name 451;
Advertiser can define date range 452 in which campaign will be active;
In a valid date range for a given day of week, advertiser can also define specific time intervals 453 in which ads from campaign should be shown on web sites;
Advertiser can also define daily budget 454 in dollar or currency amounts within which daily expenditure on ads from that campaign should be confined to;
Advertiser can select language 455 of web page on which ad should be shown;
Advertiser can select web browser type 456 on which ad should be shown;
Advertiser can select countries 457 related to requesting end user, where ads should be shown;
Advertiser can select operating systems 458 where web browser is running if should be allowed to show ads on;

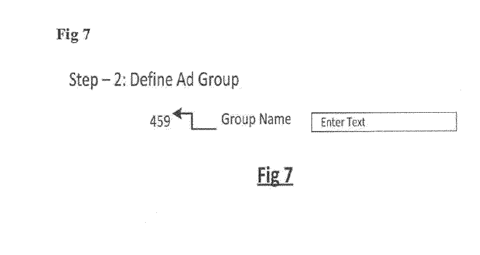

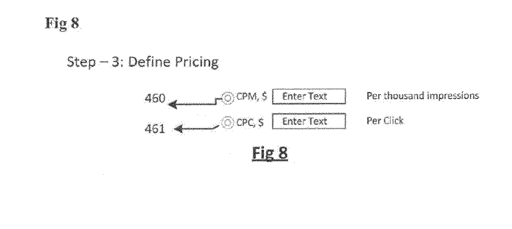

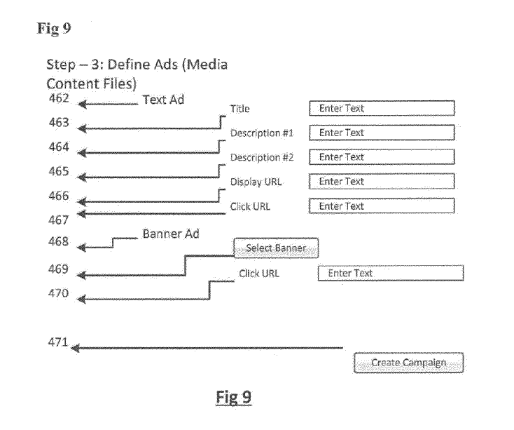

In this way advertiser can select various targeting attributes to define as what cross section of users should be seeing his ads
FIG. 7 describes Step 2 of defining ad group and shows that as 2^{nd} step of campaign creation advertiser can define ad group name. As mentioned previously a campaign is comprised of one or more ad groups, while defining a new campaign, advertiser is expected to create first ad group of campaign by defining ad group name 459.
FIG. 8 describes Step 3: Defining Pricing Model and shows, that as 3^{rd} step in campaign creation, advertiser can pick if he wants to pay based on per click or based on every 1000 display of his ads.
An advertiser has two options to pick a payment model, either select CPM (Cost Per Mille) model 460, where he will be charged defined amount for every 1000 display of his ads or he can select CPC (Cost Per Click) model 461 where he will be required to pay defined amount only if user clicks on ad.
FIG. 9 describes step 4 that is final step of campaign creation where advertiser defines either text ad or banner ad in system and finally select Create Campaign to register in system ads he wants to make live. Advertiser can define text 462 and banner ads 468. If advertiser defines text ad, he must define Title 463 of ad, Description No. 1 464, Description No. 2 465, Display URL 466 and click URL 467.
If advertiser defines banner ad, he must select some image using select banner 469.

Finally, an advertiser can click on Create Campaign 471 to register ads in system to be shown on publisher sites.

Conversion Tracking Configuration: As summarized before the system of present invention allows advertiser to achieve conversion tracking by configuring rules in portal provided by system of present invention. Subsequent sections show as how advertiser can utilize various interfaces to create data so that system can achieve desired objectives.

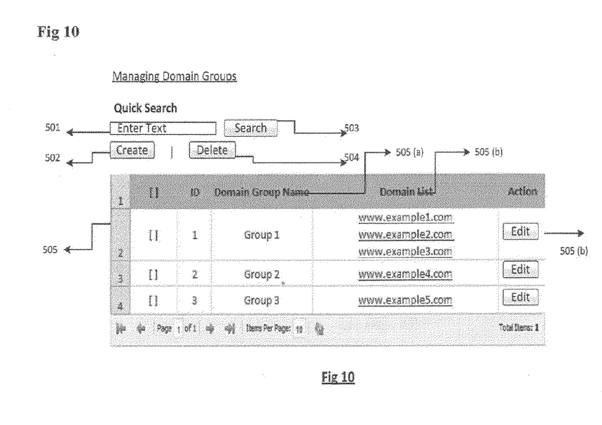

FIGS. 10 through 20 show what steps advertiser can take to define conversion tracking rules.

FIGS. 10, 11, 12, and 13 are a description of managing domain groups. The system allows an advertiser to group multiple URLs under a group and name them. This allows advertiser to manage URLs under groups efficiently. Advertiser is exposed interface as shown in FIG. 10 to define these domain groups.

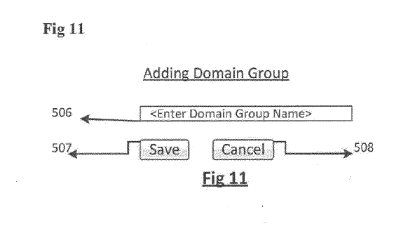

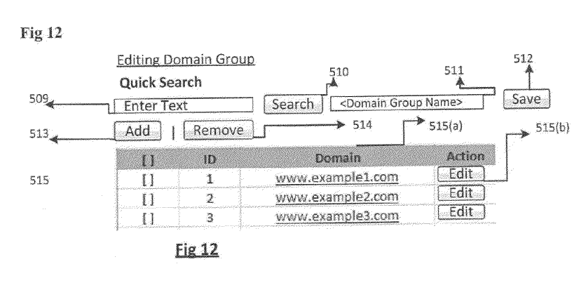

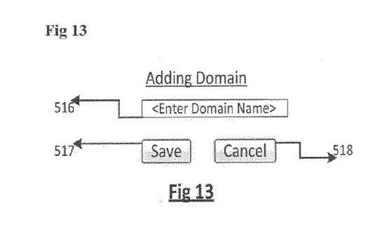

As shown in FIG. 10 advertiser can use button create 502, which will show interface as shown in FIG. 11, where advertiser can enter name 506 and press Save 507 to create a new domain group name that gets listed under domain group 505[a] as shown in FIG. 10. In order to add domains in defined domain group, next advertiser selects edit 505[b] from FIG. 10 corresponding to domain group in which he wants to define a domain; which shows interface as shown in FIG. 12. Advertiser creates new URL by pressing button Add 513 from FIG. 12, which opens up interface as shown in FIG. 13, where advertiser can define a URL in edit box 516 and click on Save button 517 to save it; saved domain will appear in domain column 515 [a] as shown in FIG. 12. Additionally advertiser can modify domain group name by entering new name in 511 and press button Save 512.

This way advertiser can create one or more domain groups.

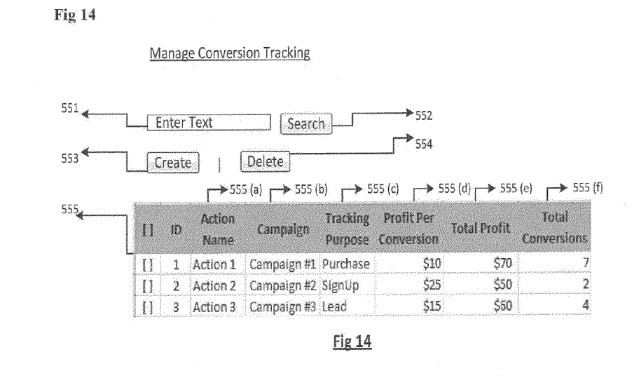

FIGS. 14, 15, 16, 17, 18, 19 and 20 provide a description for defining conversion tracking: As explained earlier first step that advertiser could use is to create domain group list as explained in FIGS. 10 to 13. After advertiser has defined domain group, he can define conversion tracking using domain groups.

FIGS. 14 through 20 explain various interfaces as used by advertiser to define conversion tracking.

The interface shown in FIG. 14 allows advertiser to manage various conversion tracking by listing name 555(a) as given by advertiser together to what campaign 555(b) it is related to by also defining tracking purpose 555(c). Advertiser also has to define profit per conversion 555(d) as what's the value of every conversion, depending on conversion he may select amount of his choice. Interface shows system computes total profit 555(e), which is total conversions 555(f) multiplied by profit per conversion 555 (d).

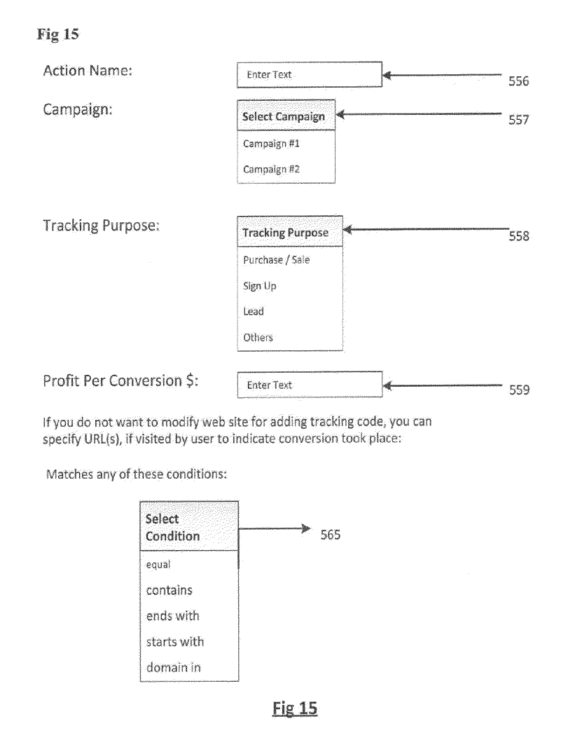

To create a new conversion, advertiser can press Create (553) button and will see interface as shown in FIG. 15.

In FIG. 15, advertiser is shown interface to define conversion tracking where he can give name to conversion as action name 556 and then he needs to select campaign 557 for which he needs to track conversion i.e. if advertiser wants to track conversions took place due to result of click on any ad in defined campaign, he should associate conversion with some campaign and that way system will track conversions for all ads in that campaign and will show conversion against a given ad as well within a campaign.

Next advertiser can select tracking purpose 558 from pre-defined tracking purposes, these are having symbolic meanings.

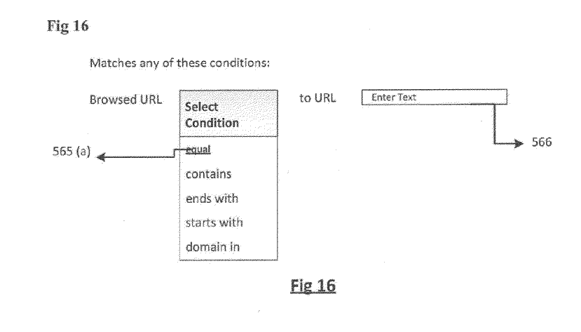

Advertiser can define profit per action value 559 associated with each conversion and finally advertiser has five conditions available to define cloud based rules 565, which if found to be matching on URL visited by end users after they have clicked on ad, system will consider conversion took place and will increment total conversions value 555 (f) as defined earlier in FIG. 14. Each of conditions shown in list box 565 is described by FIGS. 16, 17, 18, 19 and 20.

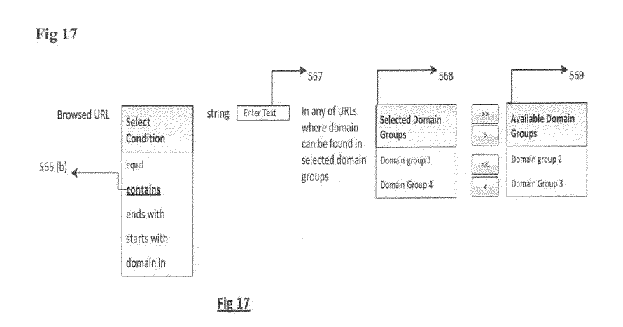

FIG. 16 shows that if an advertiser selects equal 561(a) condition, he is required to define a URL 566, which if visited by user, would mean that this rule matches. The next condition is contains 565 (b) as explained in FIG. 17.

FIG. 17 shows that if an advertiser selects contains in 565(b) condition, he is required to define a string 567, which if found on URLs based on any of domains, which are part of domain groups as selected in 568 list box, rule will be considered matching.

Advertiser is shown all domain groups defined in system under available domain groups 569 list box. FIG. 10 explains as how domain groups are defined and managed.

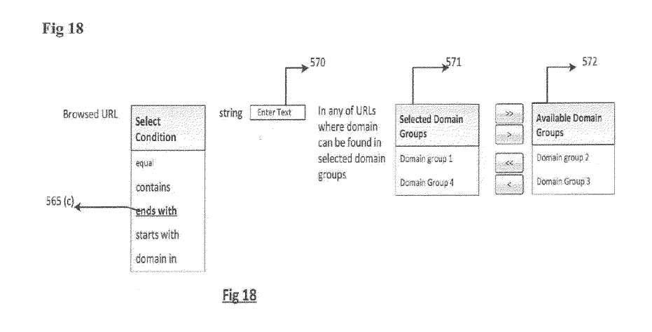

The next condition available to advertiser is ends with 565 [c] as explained in FIG. 18.

FIG. 18 shows that if an advertiser selects ends with 565[c] condition, he is required to define a string 570, which if found to end of URLs based on any of domains, which are part of domain groups as selected in 571 list box, rule will be considered matching.

Advertiser is shown all domain groups defined in system under available domain groups 572 list box. FIG. 10 explains as how domain groups are defined and managed.

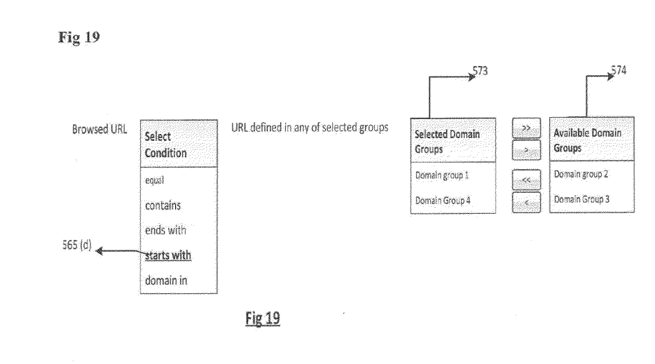

The next condition available to advertiser is starts with 565 [d] as explained in FIG. 19.

FIG. 19 shows that if an advertiser selects starts with 565(d) condition, he is required to simply select one or more domain groups 573 and if any URL browsed by users starts with any domain defined under any of selected domain groups 573, rule will be considered matching.

Advertiser is shown all domain groups defined in system under available domain groups 574 list box. FIG. 10 explains as how domain groups are defined and managed.

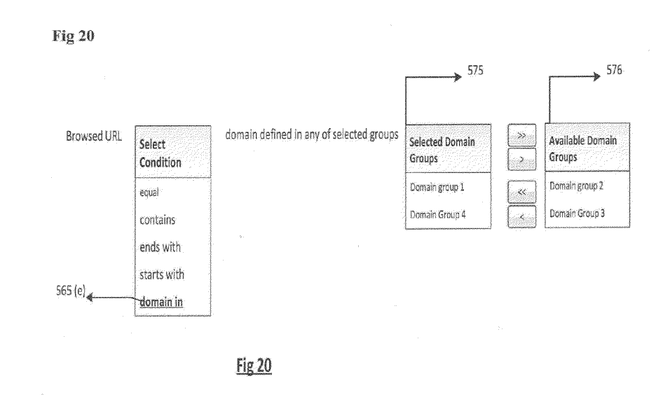

The next condition available to advertiser is domain in 565 [e] as explained in FIG. 20.

FIG. 20 shows that if an advertiser selects domain in 565(e) condition, he is required to simply select one or more domain groups 575 and if master domain of any URL browsed by user matches with any domain defined under any of selected domain groups 575, rule will be considered matching.

Advertiser is shown all domain groups defined in system under available domain groups 576 list box. FIG. 10 explains as how domain groups are defined and managed.

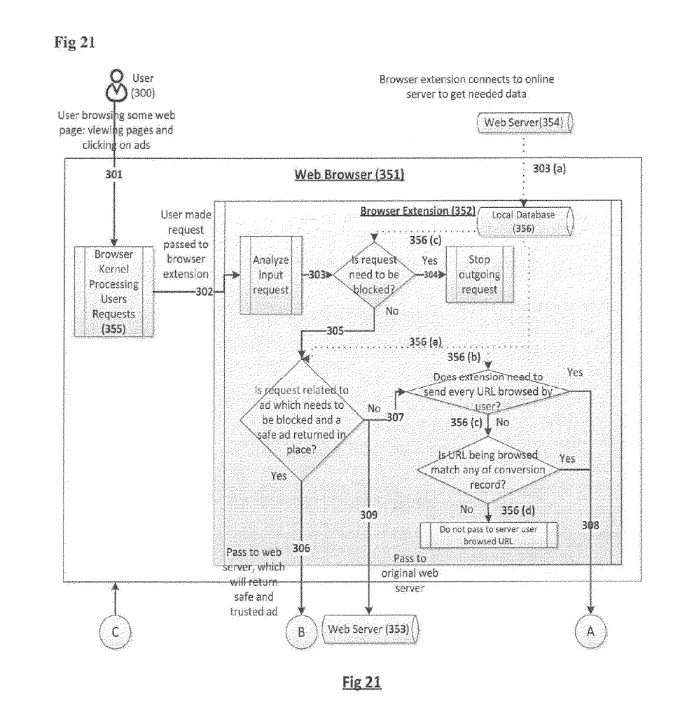

FIGS. 21-23 are descriptions, which explain use of data, which is created as described from FIG. 6 to FIG. 20 by advertiser. Definitions from FIGS. 21 to 23 define the core of the system of present invention. These definitions essentially define core data usage with the present invention.

FIG. 21 describes how a user 300 browses using a web browser 351, which has browser extension 352 installed, the browsing request 301 goes to browser kernel 355, which passes it to installed browser extension 352 for any decision about blocking/redirection. When browser extension receives the request 302, it checks its internal local database 356, which is being periodically fed by online webserver 354, to make a decision if a given user request should be blocked, re-directed or web server 357 should be informed if user browsed this URL.

In case extension 352 decides that request matches entry in local database that needs to be blocked, browser stops outgoing request and request is dropped by web browser as shown by flow 304.

Request 305 is analysed, if it needs to be re-directed to return safe ad using flow 356(a) connection to local database 356; if request needs to be re-directed control is passed via flow 306 to on page reference B, if it is not to be re-directed as shown in flow 309 request is passed to original web server 353 to which request was destined initially and additionally browser extension 352 can be informed by database 356 for three possible values:

The first value is being determined via flow 356 (b) if browser extension should send every URL being browsed by user or not if flag is set, browser extension passes to server 357 this URL via on page reference A as shown via flow 308.

The second value indicates if browser extension needs to check browsed URL to be on a domain defined in one of domain groups associated with any conversion as described in FIG. 10 to FIG. 20 in previous sections and shown via flow 356(c) and if yes, browser extension 352 passes to server 357 this URL via on page reference A as shown via flow 308.

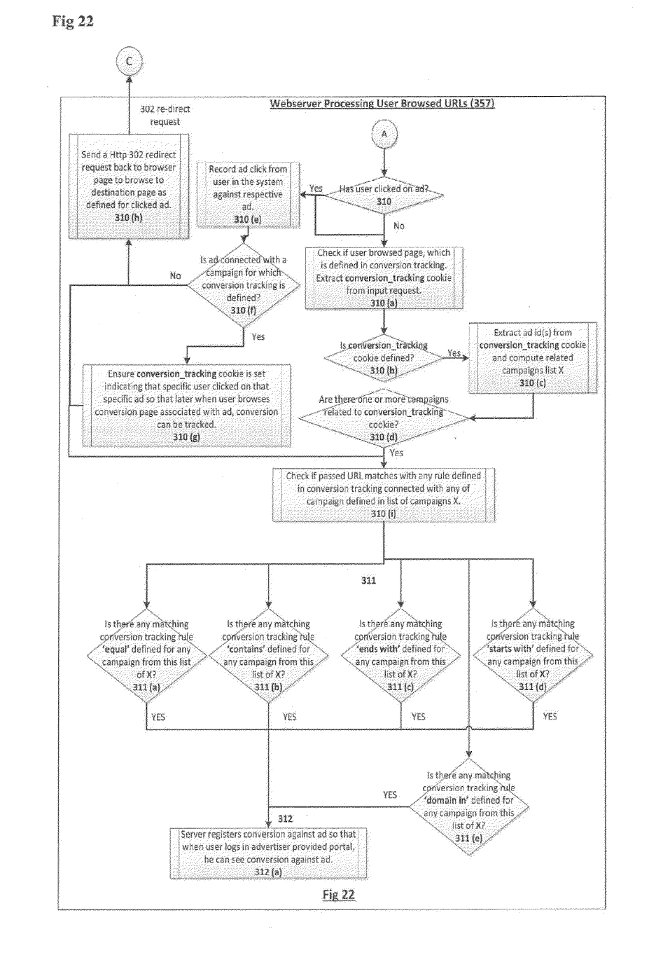

FIG. 22 demonstrates that as soon as user browsed URL data is received, system of present invention checks if incoming request indicates that user clicked on an ad, if yes, then it registers click against respective ad as shown in box 310 (e), next it checks if ad, which is clicked by user is connected with a campaign, which is having any associated conversion defined, if yes as shown via box 310 g, system ensures that it sets conversion_tracking cookie so that when next time user browses a page, which may be matching any URL rule defined in one of conversions. Finally as user has clicked on ad and system has registered click against ad, browser needs to be sent destination URL as defined by advertiser while defining ad as explained in FIG. 9 so system of present invention sends a 302 HTTP request as indicated in 310(h) together with indicating to web browser to navigate to destination URL as defined by advertiser.

In case at decision box 310 system of present invention decides that incoming request is not for ad click but user has browsed to a page, it checks if user has conversion_tracking cookie set as shown in 310 (b) to check if system needs to see if browsed URL matches with any defined conversion. In case conversion_tracking cookie is defined, system extracts ad ids from it as indicated in 310 (c) and checks if there are one or more active campaigns related ids defined in conversion_tracking cookie, if yes, URL is matched using conversion rules defined against each campaign i.e. if ‘equal’ rule matches as shown in 311(a) and earlier described in FIG. 16; if ‘contains’ rule matches as shown in 311(b) and earlier described in FIG. 17; if ‘ends with’ rule matches as shown in 311(c) and earlier described in FIG. 18; if ‘starts with’ rule matches as shown in 311(d) and earlier described in FIG. 19; if ‘domain in’ rule matches as shown in 311(e) and earlier described in FIG. 20.

If any of rule matches in any conversion, via flow 312 control is passed to sub processing box 312 (a) and conversion is recorded against ad.

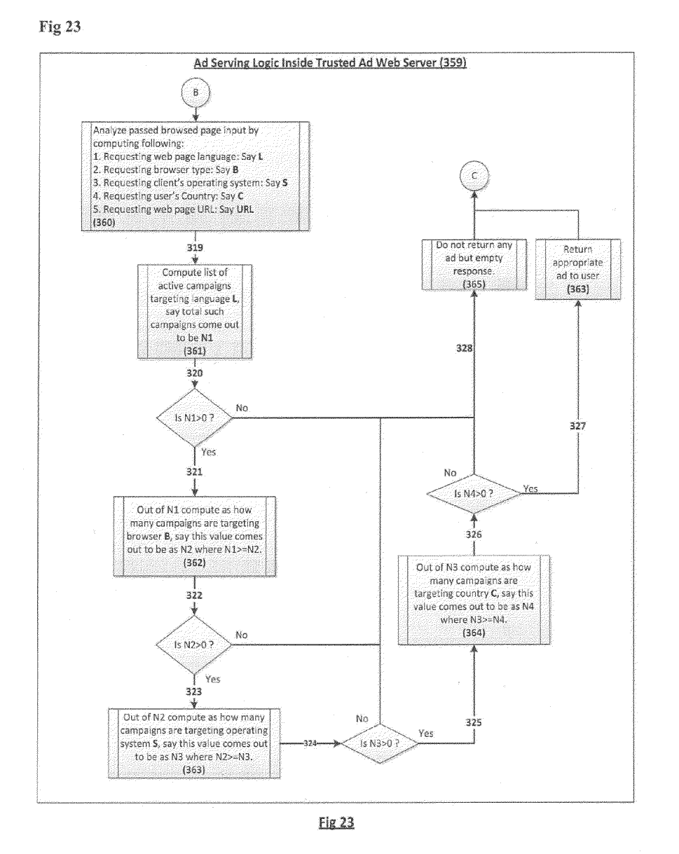

FIG. 23 describes and illustrates ad delivering process inside webserver 359 when browser extension as described in FIG. 21 makes a request for ad as indicated in FIG. 21 via on page reference B. First, it is computing from incoming request in box 360 as what's the language L of web page where ad is requested from, what is requesting browser type B, on what operating system S web browser is running and in what country C request is originating from and finally URL itself is noted down to return appropriate ad from system.

In sub processing box 361 it is found out as how many active campaigns want to show ads on web pages with language L and it is computed how many and which are those campaigns as N1. In case N1 is non-zero, flow is shown via 321 and next decision in sub process box 362 is made as how many campaigns out of N1 are targeting browser B and computed that count as N2. In case N2 is non-zero as shown via flow 323, sub process box 363 finds out how many campaigns out of N2 are targeting operating system S and this number is computed as N3. In case N3 is non-zero, flow is shown via 325 where in sub process box 364 it is computed out of N3 as how many campaigns are targeting a specific country C and total campaigns are computed as N4. In case N4 is non-zero as shown via flow 327, decision to return relevant ad as system may find suitable for best return for the system.

In case of N1, N2, N3 or N4 is zero, control is passed via flow 328, no ad is returned as shown via sub process box 365.

This following description is a non-limiting example as to how the entire system works. A user to see advertisements from this system of present invention, the first thing he does is installs the specific browser extension as described in FIG. 21. After he has browser extension installed, when he browses internet, as explained in FIG. 2 all requests from browser pass through browser extension and browser extension is free to stop or re-direct a given request or just inform system of present invention server as what URL was browsed by user.

This specific extension connects to web server 354 as explained in FIG. 21 as what requests to block and what requests to re-direct and also for what all requests just inform it that user browsed a specific URL.

Assume there is an advertiser X selling shirts, he may be interested in knowing how many purchases are made due to user coming to his site after clicking on his ad and he is not interested in modifying his web site for any html code, all he knows as what will be final web page that user will see after he completes the purchase.

So what he will do is he will sign up in system as defined in FIG. 5 and will then submit his ad by defining campaign as described from FIG. 6 to FIG. 9. In FIG. 6, say he defines name of campaign in campaign name 451 field as shirt_campaign and then fills other available options in FIG. 6. Then in FIG. 7 say he defines ad group name as shirt_adgroup and finally in FIG. 9 say he gives name of ad is shirt_ad and defines text or banner ad for it finally defining click URL http://example.com/buyshirts.html in field 467 or 470 depending if he chose text ad or banner ad respectively. As explained in FIG. 9 description, in case user clicks on ad, he is taken to click/destination URL, so advertiser must define as where he intends user to go after clicking on his ad.

Now as advertiser is interested in cloud based conversion tracking and he knows if someone buys shirts he has to go to final page after payment processing confirmation say http://example/com/thankyou.html, he will use interface as defined in FIG. 14 by clicking on Create button 553, which will take him to FIG. 15, where he can give some custom name to this conversion say “shirt_conversion” in edit box 556, then he will be able to see in list box 557 campaign shirt_campaign as created earlier and then he can select from tracking 558 list box purpose as ‘Purchase/Sale’ and could define profit per conversion 559 value say as $20.

Next he will select equal condition from 565(a) as described in FIG. 16 and define value of URL 566 to track conversion against as http://example/com/thankyou.html

As described in FIG. 21, when user browses internet, he may end up seeing shirt_ad as defined by advertiser and explained in FIG. 23. In case he clicks on ad as described in FIG. 22, against user conversion_tracking cookie is set as shown in FIG. 22 under 310 (g) process box. In case user makes a purchase and ends up browsing to http://example/com/thankyou.html as shown in FIG. 22 under decision box 311 (a), browsed URL will be matched and as shown in FIG. 22 under process box 312 (a) conversion will be registered against shirt_ad.

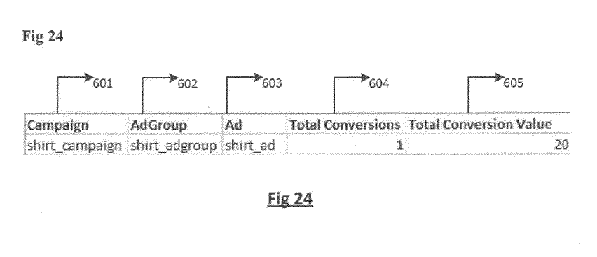

FIG. 24 shows as how advertiser will be able to see number of conversions for a given campaign/adgroup and ad. Interface shows per campaign, ad groups and then further showing ads for which conversion has taken place by showing campaign name 601, ad group name 602, ad 603 and total conversions 604 against a given ad and final column total conversion value showing how much money advertiser expects to make out of conversions, which is computed as total conversions multiplied by profit per conversion 559 as defined in FIG. 15.

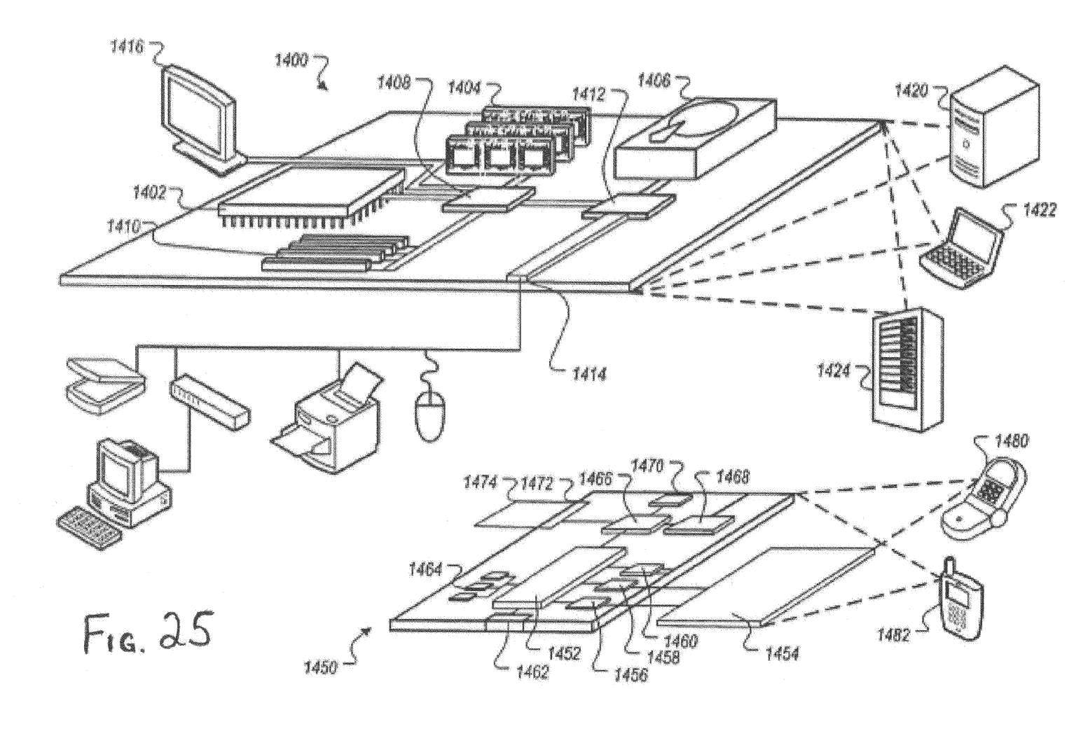

FIG. 25 shows an example of a generic computer device 1400 and a generic mobile computer device 1450, which may be used to implement the processes described herein, including the mobile-side and server-side processes for installing a computer program from a mobile device to a computer. Computing device 1400 is intended to represent various forms of digital computers, such as laptops, desktops, workstations, personal digital assistants, servers, blade servers, mainframes, and other appropriate computers. Computing device 1450 is intended to represent various forms of mobile devices, such as personal digital to assistants, cellular telephones, smartphones, and other similar computing devices. The components shown here, their connections and relationships, and their functions, are meant to be exemplary only, and are not meant to limit implementations of the inventions described and/or claimed in this document.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412 are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple busses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of functions is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port 1414, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a microdrive or other device, to provide additional storage. Each of the components 1450, 1452, 1464, 1454, 1466, and 1468 are interconnected using various busses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT LCD (Thin-Film-Transistor Liquid Crystal Display) or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 1474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provide as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, memory on processor 1452, or a propagated signal that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, Wi-Fi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A system for cloud based conversion tracking of a multimedia content file comprising:
a computer having a microprocessor and a memory connected to a processor bus, said processor bus connected by circuitry to a periphery bus and a disk;
said computer operated by a user and in communication with a web server and a database server via a web browser and at least one web site, said web browser having a browser extension;
said computer in communication with a domain name system server;
said web site receiving at least one multimedia content file from a multimedia content provider;
said user browsing said at least one web site and accessing said at least one multimedia content file;
wherein said browser extension provides said multimedia content provider ability to achieve conversion tracking without modifying said web site.

2. The system of claim 1 further comprising,
a browser kernel processing requests of said user; said requests communicated to said browser extension;
said browser extension analyzing said requests by a first predetermined rule to determine which of said requests need to be blocked;
said browser extension analyzing by a second predetermined rule said requests which are not blocked by said first predetermined rule to determine which of said requests should be communicated to said web server;
said browser extension sending to said web server said requests which are not blocked by said second predetermined rule.

3. The system of claim 2 wherein said first predetermined rule includes determining if said requests are for said at least one multimedia content file and said at least one multimedia content file is unsafe.

4. The system of claim 3 wherein said unsafe at least one multimedia content file is replaced by a safe multimedia content file.

5. The system of claim 2 wherein said second predetermined rule includes determining if said browser extension should communicate all URLs browsed by said user to said web server.

6. The system of claim 5 wherein said second predetermined rule further includes determining if said URLs browsed by said user match any conversion record.

7. A method of processing user browsed websites comprising,
operating a computer by a user and said computer in communication with a web server and a database server via a web browser and at least one web site, said web browser having a browser extension; said computer in communication with a domain name system server;
said web site having at least one multimedia content file received from a multimedia content provider;
browsing said at least one web site;
accessing said at least one multimedia content file;
recording access of said at least one multimedia content file by said user;
connecting said at least one multimedia content file with a distribution campaign by a provider of said at least one multimedia content file;
placing a conversion tracking cookie of said at least one multimedia content file on said computer of said user and said conversion tracking cookie is associated with said user;
matching said browsed at least one web site with a conversion tracking rule associated with said distribution campaign;
matching a conversion tracking rule defined for said at least one campaign;
registering a conversion against said at least one multimedia content file at said database server;
displaying said conversion against said at least one multimedia content file for said provider of said at least one multimedia content file to view.

8. The method of claim 7 further comprising,
processing requests of said user with a browser kernel; said requests communicated to said browser extension;
said browser extension analyzing said requests by a first predetermined rule to determine which of said requests need to be blocked;
said browser extension analyzing by a second predetermined rule said requests which are not blocked by said first predetermined rule to determine which of said requests should be communicated to said web server;
said browser extension sending to said web server said requests which are not blocked by said second predetermined rule.

9. The method of claim 8 wherein said first predetermined rule includes determining if said requests are for said at least one multimedia content file and said at least one multimedia content file is unsafe.

10. The method of claim 9 wherein said unsafe at least one multimedia content file is replaced by a safe multimedia content file.

11. The method of claim 8 wherein said second predetermined rule includes determining if said browser extension should communicate all URLs browsed by said user to said web server.

12. The method of claim 11 wherein said second predetermined rule further includes determining if said URLs browsed by said user match any conversion record.
